(19) United States
(12) Patent Application Publication
(10) Pub. No.: US 2025/0149826 A1
(43) Pub. Date: May 8, 2025

(54) ELECTRICAL CONNECTOR ASSEMBLY, ELECTRICAL MATING CONNECTOR, LOCKING ELEMENT AND SET FORMED OF A CONNECTOR, A MATING CONNECTOR AND A LOCKING ELEMENT

(71) Applicant: WAGO Verwaltungsgesellschaft mbH, Minden (DE)

(72) Inventor: Rudolf MASTEL, Minden (DE)

(73) Assignee: WAGO Verwaltungsgesellschaft mbH, Minden (DE)

(21) Appl. No.: 18/934,958

(22) Filed: Nov. 1, 2024

(30) Foreign Application Priority Data
Nov. 3, 2023 (DE) 20 2023 106 436.1

(51) Int. Cl. H01R 13/627

(52) U.S. Cl. CPC H01R 13/6272

(57) ABSTRACT

An electrical connector assembly comprising a connector and a mating connector, each of which has electrical plug-in contact elements assigned to each other. A locking element is arranged on the connector for mechanically locking the connector to the mating connector. The locking element is arranged for a detachable attachment to the mating connector. The locking element has a guide section with a form-fit profile and tht the mating connector has a guide seat with a form-fit contour for the form-fitting mounting and guiding of the locking element on the mating connector.

This nonprovisional application claims priority under 35 U.S.C. § 119(a) to German Patent Application No. 20 2023 106 436.1, which was filed in Germany on Nov. 3, 2023, and which is herein incorporated by reference.

### BACKGROUND OF THE INVENTION

### Field of the Invention

The invention relates to an electrical connector assembly comprising a connector and a mating connector, each having electrical plug-in contact elements assigned to each other, and having a locking element arranged on the connector for mechanically locking the connector to the mating connector, wherein the locking element is a detachable attachment to the mating connector. The invention also relates to an electrical mating connector and a locking element for such a connector assembly. The invention also relates to a set comprising a connector, a mating connector and a locking element for such a connector assembly.

### Description of the Background Art

In general, the invention relates to the field of electrical connection technology. An electrical connector assembly is used to easily and quickly establish a detachable electrical connection between an electrical connector and an electrical mating connector. To establish the electrical connection, the connector and the mating connector each have electrical plug-in contact elements assigned to each other.

To mechanically secure the plug-in connection between the connector and the mating connector, it is known to lock them together with a locking element. For example, the locking element can be permanently attached to the connector or a detachable separate accessory.

### SUMMARY OF THE INVENTION

It is therefore an object of the invention to provide a connector assembly with an easy-to-handle and reliably effective mechanical locking mechanism. In particular, the risk of unintentional loosening of the locking mechanism in the event of tensile forces acting on the locking element is to be reduced.

According to an example, a connector assembly is provided comprising a connector and a mating connector, each of which has electrical plug-in contact elements assigned to each other, and having a locking element arranged on the connector for mechanically locking the connector to the mating connector, wherein the locking element is arranged for a detachable attachment to the mating connector, wherein the locking element has a guide section with a positive fit profile and wherein the mating connector has a guide seat with a positive fit contour for the positive fit and guidance of the locking element on the mating connector. In other words, a connector assembly is created in which the locking element can be immersed in a designated receptacle of the mating connector and can be held therein and guided in a form-fitting manner.

The connector assembly increases the secure connection and the locking forces, also referred to as locking security in the following, between the connector and the mating connector and reliably secures the locking mechanism against unintentional loosening in the event of tensile forces. By supporting the locking element at the guide seat of the mating connector and a positive fit between the positive fit profile of the locking element and the form-fit contour of the mating connector, the locking element is stabilized and the attachment of the locking element to the mating connector is secured. Due to the increased locking security, it is possible to reliably lock even small and compact connector assemblies. In addition, due to the increased locking security, for example, the structure for fastening the locking element to the connector can be dimensioned smaller. Furthermore, due to the improved locking security, the locking element can be designed with a higher elasticity or lower bending stiffness, thus achieving improved handling of the locking element.

The connector and mating connector can have plug-in contact elements assigned to each other. In this case, an assignment to each other can mean that the plug-in contact element of the connector is set up to connect to a corresponding plug-in contact element of the mating connector, for example, plug-in contact elements assigned to each other have matching mating contours. For example, the connector may have a pin as the plug-in contact element and the mating connector may have a pin socket matching the pin as the plug-in contact element, or vice versa. The connector and the mating connector can also each have several plug-in contact elements, so that the plug-in contact elements of the aforementioned connectors can be designed, for example, as pin headers and corresponding socket headers. A surface of the connector or mating connector on which at least one of the plug-in contact elements is located can be referred to as a mating face. In addition, the mating face can have at least one coding element through which the connector and the mating connector must be plugged together in a specified orientation to each other so that mismating can be reliably prevented.

A guide section of the locking element can be an area of the locking element that is suitable for routing in a suitable receptacle of a mating connector. The guide section may be provided in particular on an outer contour of the locking element, for example on a component edge of the locking element. The guide section may be located on an end section of the locking element facing the mating connector. The guide section may be adjacent to a mating face of the connector if the locking element is located on the connector. The guide section can have a positive fit profile that is formed by a specific geometric shape of the locking element in the guide section. For example, the form-fit profile can be formed by a contour part that protrudes from a basic shape of the locking element. In particular, the form-fit profile can be a lateral form-fit profile that is formed on a lateral component edge of the locking element. For example, a lateral component edge of the locking element may extend parallel to a mating direction of the connector if the locking element is located on the connector and the connector is moved in the mating direction towards the mating connector. The locking element may be predominantly flat in its guide section, wherein the form-fit profile may be formed on its lateral edge or edge surfaces. In the proposed connector assembly, the locking element is arranged on the connector, for example, detachable or permanently attached to it. The locking element can extend predominantly along the connector, for example, more than 70% or more than 80% of a surface of the locking element facing the connector can extend along the surface of the connector.

A guide seat of the mating connector can be an area of the mating connector where the guide section of the locking element can be routed. For example, the guide seat can form a linear guide for the locking element, in which the guide section of the locking element is translationally movable. For example, the guide seat may have one or more grooves with a shape that matches the form-fit profile of the locking element, which forms or form a form-fit contour for the form-fit profile. For example, the form-fit contour can represent a negative shape of the form-fit profile of the locking element. For example, the form-fit contour may be formed by a contour part that recesses from a basic shape of the mating connector. The guide seat can be formed on a mating connector housing of the mating connector.

The dimensions of the mating connector guide seat and the locking element guide section can be designed to have a clearance fit to allow for easy insertion and displacement of the locking element in the mating connector.

A positive fit or a positive guide can be understood as a technical connection or guide in which the connection or guide partners, in this case the guide section of the locking element and the guide seat of the mating connector, are geometrically contoured to match each other and engage with each other.

The locking element form-fit profile may be designed to undercut the form-fit contour of the mating connector. An undercut can be used to achieve a reliable positive fit. In the case of an undercut, an effective surface of the positive fit profile and an effective surface of the positive fit contour may be arranged in such an overlapping manner that at least one degree of freedom of the positive fit profile guided in the positive fit contour is blocked. In other words, the form-fit profile is designed to engage behind the form-fit contour.

The overlapping arrangement of the form-fit profiles of the locking element and the mating connector or the undercut prevents the flat guide section from deflecting perpendicular to the surface extension of the guide section in the event of tensile loads. This effectively prevents unintentional loosening of the locking in a structurally simple manner.

A profile element of the form-fit profile may be formed on a side contour of the locking element. For example, the side contour may extend substantially parallel to one mating direction of the connector if the locking element is located on the connector and the connector is moved in the mating direction toward the mating connector. For example, the side contour can extend essentially orthogonally to an end edge of the locking element facing the mating connector. For example, the side contour may extend essentially orthogonally to a fastening edge of the locking element that is provided to be attached to the mating connector. A connector mating direction can be a displacement direction of the connector toward the mating connector with facing plug-in contact elements to establish an electrical connection. If the connector is moved in the mating direction toward the mating connector, the locking element attached to the connector, for example, can be inserted into the guide seat of the mating connector. A profile element can be a component of the form-fit profile, for example a contour section of the form-fit profile that can be included in the form-fit contour, for example a protrusion. If a profile element of the form-fit profile is formed on a side contour of the locking element, it is possible to guide the locking element sideways in the guide seat. This allows for the locking element to be easily inserted into the guide seat. In addition, a compact guidance option is provided without a significant increase in installation space. Furthermore, the locking element can be advantageously stabilized laterally, so that tensile forces cannot lead to an unintentional release of the locking element. The profile element can extend over the entire side contour of the locking element, which can be associated with a simplified production of the locking element, or only over part of the side contour, for example to limit the insertion depth of the locking element into the guide seat or to provide a visual inspection option for the locking status.

One profile element of the form-fit profile can be formed on two opposing side contours of the locking element. This allows for the locking element to be guided on both sides in the guide seat, so that the locking security is further increased and a two-sided or symmetrical support and force transmission of the locking element at the guide seat is possible. In other words, the locking element has profile elements on both sides, which together form the form-fit profile of the locking element. In this case, the profile elements can be geometrically essentially identical on both side contours, wherein a laterally inverted or mirrored design of the profile elements can be regarded as an essentially identical design. In principle, it is also conceivable to design the profile elements on both side contours geometrically differently, for example by providing different basic geometric shapes.

The form-fit profile of the locking element and the form-fit contour of the mating connector can be formed as correspondingly inclined surfaces. This makes it easy to achieve a positive fit between the guide section of the locking element and the guide seat of the mating connector. For example, opposite bevels of the positive fit profile and the positive fit contour may have a substantially identical slope, allowing for the bevels to run parallel to each other and slide off each other in the guide seat of the mating connector when the locking element is guided in the guide section. The inclined bevel surface of the form-fit contour allows for a cross-section extension to be formed in the guide seat, which enables undercutting with the bevel surface of the form-fit profile and form-fitting guidance. On the form-fit contour and on the form-fit profile, two spaced bevel surfaces with opposing angles of inclination may be provided. As a result, for example, the form-fit contour, starting from a component contour adjacent to the form-fit contour, may have a conical cross-sectional extension of the guide seat, and the form-fit profile, starting from a component contour adjacent to the form-fit profile, may have a conical cross-sectional extension of the guide section, wherein the conical cross-sectional extensions of the locking element and the mating connector are designed to match each other, resulting in a secure form-fitting guidance.

The form-fit profile can be designed as a symmetrical form-fit profile and the form-fit contour as a symmetrical form-fit contour. This provides a symmetrical positive fit that allows for uniform force application of the guide section of the locking element into the guide seat of the mating connector. To form a symmetrical form-fit profile, for example, in each case a profile element of the same geometric design can be formed on two opposing side contours of the locking element. To form a symmetrical form-fit contour, for example, in each case a groove corresponding to the profile elements can be formed on two opposing inner contours of the guide seat.

The form-fit profile can be designed as an asymmetrical form-fit profile and the form-fit contour as an asymmetrical form-fit contour. This allows for an asymmetrical form-fit to be provided, which can be used to achieve an additional coding function, for example. To form an asymmetrical form-fit profile, for example, different profile elements can be formed on two opposing side contours of the locking element or only one profile element can be formed on only one side contour. To form an asymmetrical form-fit contour, for example, a groove corresponding to the different profile elements can be formed on two opposing inner contours of the guide seat, or only one groove can be formed on an inner contour of the guide seat.

The form-fit profile can be designed as a dovetail profile and the form-fit contour as a dovetail contour. This makes it easy to create a reliable positive fit. The dovetail profile can be shaped and dimensioned to match the dovetail contour, with an advantageous clearance fit to facilitate the insertion and guiding of the guide section of the locking element to the guide seat. The dovetail profile and dovetail contour may have a cross-section reduction perpendicular to the mating direction of the connector, so that the dovetail profile can engage behind the dovetail contour in a form-fitting manner and the guide section is secured against falling out of the guide seat.

In principle, other form-fitting geometries are also conceivable as an alternative or in addition to a dovetail geometry, which can be based on a T-profile, a mushroom profile or a round head profile, for example.

The locking element may have a first fastening structure for attaching the locking element to the connector. In particular, the first fastening structure may be designed for detachably attaching the locking element to the connector. In particular, the first fastening structure may be designed for tool-free attachment of the locking element to the connector. The first fastening structure can be integrally formed with the locking element. Examples of such fastening structures can be a plug contour or a clamping structure. The connector can have a mounting structure to accommodate the first fastening structure of the locking element, such as a plug-in opening. Alternatively or additionally, it is conceivable that the connector has a first fastening structure for attaching the locking element to the connector.

The locking element may have a second fastening structure for attaching the locking element to the mating connector. The second fastening structure may be designed in particular for detachable attachment of the locking element to the mating connector. The second fastening structure can be integrally formed with the locking element. In particular, the second fastening structure may be designed for tool-free fastening of the locking element to the mating connector. This allows for the connector to be locked to the mating connector by means of the locking element. The mating connector may have a mounting structure to accommodate the second fastening structure of the locking element, which is designed for a positive connection. For this purpose, a form-fit profile of the locking element can be set up to undercut a form-fit contour of a guide seat of the mating connector, so that a reliable form-fit is achieved through the associated overlapping of the effective surfaces of the form-fit profile and the form-fit contour.

The mating connector has a second fastening structure for attaching the locking element to the mating connector. The second fastening structure of the locking element may be spaced apart from any existing first fastening structure of the locking element, in particular at a distance corresponding to a distance between a mounting structure of the mating connector and a mounting structure of the connector in its mated state. The second fastening structure may be located closer to a free end section of the locking element facing the mating connector than the first fastening structure. The fastening structure can be designed as a locking structure, for example in that a locking edge on the mounting structure forms a detent stop for a locking tab on the locking element. This allows for the locking element to be detachably attached to the mating connector without the need for tools.

According to an advantageous further development regarding fastening structures of the locking element, the first fastening structure and/or the second fastening structure can be designed as a locking structure. A locking structure can be, for example, a latching nose, a latching tab, a latching hook or a latching nub. A locking structure can be elastically deformable and detachable on a mounting structure of the connector or mating connector, which can be designed, for example, as a snap-in edge or latching opening. By means of a locking structure, a very simple, tool-free and detachable attachment of the locking element to the connector and/or the mating connector is possible. In addition, the locking structure or the locking structures can be formed in one piece with the locking element. In this case, the entire locking element may be made of a predominantly elastic material, which, depending on its shape, gives it elastic deformability, at least in sections, so that a locking process and a release process from the locking can be easily carried out. With a locking element that can be elastically deformed at least in sections, the advantages described above of a stabilizing guidance of the guide section of the locking element in the guide seat of the mating connector have an increased effect, since easy handling of a locking element that can be elastically deformed at least in sections is combined with increased locking security against unintentional detachment of the locking element from the mating connectors.

The locking element can have an unlocking element. The unlocking element can be a mechanical element that can enable or facilitate an intentional detachment of the locking element from the mating connector. For example, the unlocking element may be set up to detach the second fastening structure of the locking element from the mating connector. The unlocking element can be, for example, an elastically deformable tab, which can be set up, for example, to displace a locking structure of the locking element from a locking position in which the locking structure is engaged with a mounting structure of the mating connector. The unlocking element can be, for example, a lever for levering out a locking hook. The unlocking element can, for example, be arranged between two side contours of the locking element, on which at least one profile element can be formed, and partially span the locking element as an elastically deformable tab in the form of a bridge.

The locking element can be designed as a locking latch. In the field of electrotechnical connection technology, locking latches are predominantly flat accessory elements for connector assemblies for locking the connector to the mating connector. They can be set up as individually available accessories to be arranged either on a connector or a mating connector and to fix them to each other.

The connector assembly may have a connecting component that extends adjacent to the guide seat of the mating connector. A guide section of the locking element guided in the guide seat can therefore additionally support itself against the connecting component, so that the locking security is further increased. The connecting component can limit the guide seat on an open side of the guide seat. The connecting component can be, for example, a flat circuit carrier such as a printed circuit board.

The invention also relates to an electrical mating connector for a connector assembly according to any one of the features described above, wherein the mating connector has a guide seat with a form-fit contour for the form-fitting mounting and guiding of a locking element. Such a mating connector can advantageously increase the locking security of the connector assembly formed with the mating connector and the locking of the connector assembly is reliably secured against unintentional loosening in the event of tensile forces acting on the locking element.

The mating connector may be advantageously designed according to one of the features described in the context of the proposed connector assembly, such as: have a form-fit contour that is set up to undercut with a form-fit profile of the locking element; have a form-fit contour with an inclined bevel surface; have a symmetrical form-fit contour; have an asymmetrical form-fit contour; have a dovetail contour as a form-fit contour; have a mounting structure for a second fastening structure of the locking element, such as a locking edge or latching opening; and/or have a connecting component that extends adjacent to the guide seat.

The invention also relates to a locking element for a connector assembly according to any one of the features described above, wherein the locking element has a guide section with a form-fit profile. With such a locking element, the locking security of the connector assembly formed with the locking element can be advantageously increased and a locking of the connector assembly is reliably secured against unintentional loosening in the event of tensile forces acting on the locking element.

The locking element may be advantageously designed according to any one of the features described in the context of the proposed connector assembly, such as: have a form-fit profile set up to undercut with a form-fit contour of a mating connector of the connector assembly; have a profile element of the form-fit profile formed on a side contour of the locking element; in each case have a profile element of the form-fit profile on two opposing side contours of the locking element; have a form-fit profile with an inclined bevel surface; have a symmetrical form-fit profile; have an asymmetrical form-fit profile; have a dovetail profile as a form-fit profile; have a first fastening structure for fastening the locking element to a connector of the connector assembly, wherein, for example, the first fastening structure is designed as a snap-in structure; have a second fastening structure for fastening the locking element to the mating connector, wherein the second fastening structure is designed as a locking structure, for example; have an unlocking element; and/or be designed as a locking latch.

The invention also relates to a set formed of a connector, a mating connector and a locking element for forming a connector assembly according to any one of the features described above. The proposed set can also achieve the advantages of increased locking security described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a to 1b show a connector for a connector assembly in a perspective bottom view and a front view;

FIGS. 2a to 2d show a mating connector for a connector assembly in a perspective plan view, a front view, a cut side view, and a perspective bottom view;

FIGS. 3a to 3c show a locking element for a connector assembly in a perspective plan view, a perspective bottom view and a side view;

FIGS. 4a to 4d show a connector according to FIGS. 1a-1b with a locking element arranged therein in accordance with FIGS. 3a-3c in a perspective bottom view, a front view, a cut side view and a partially cut rear view;

FIGS. 5a to 5c show a connector assembly comprising a connector in accordance with FIGS. 1a-1b, a mating connector in accordance with FIGS. 2a-2d, and a locking element in accordance with FIGS. 3a-3c in a perspective bottom view, a front view, and a partially cut side view.

### DETAILED DESCRIPTION

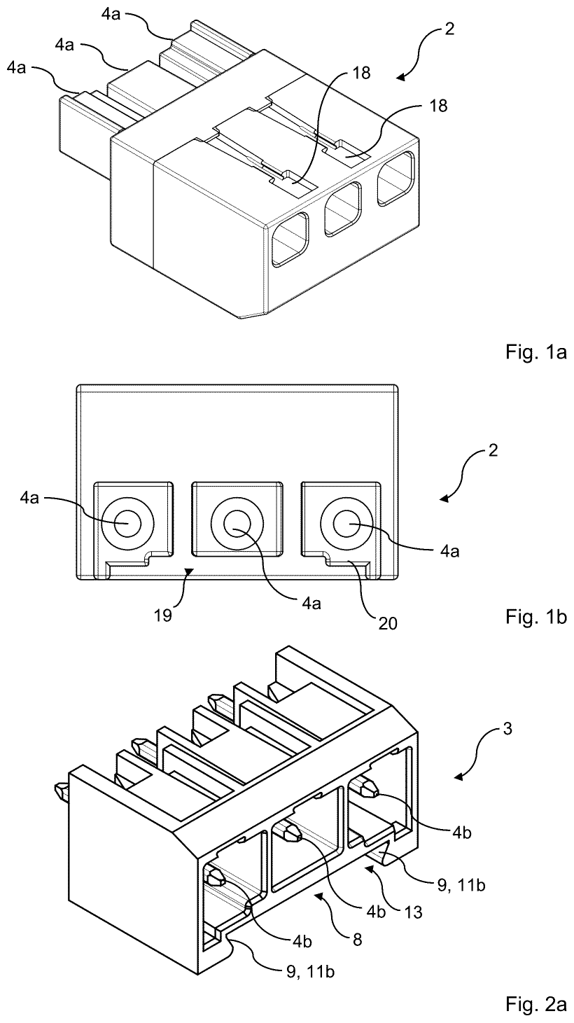

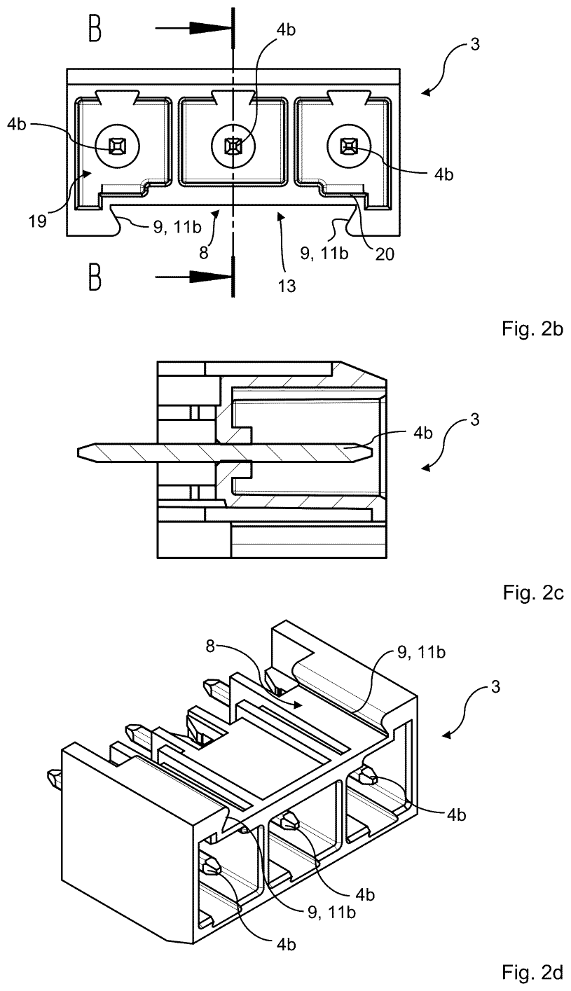

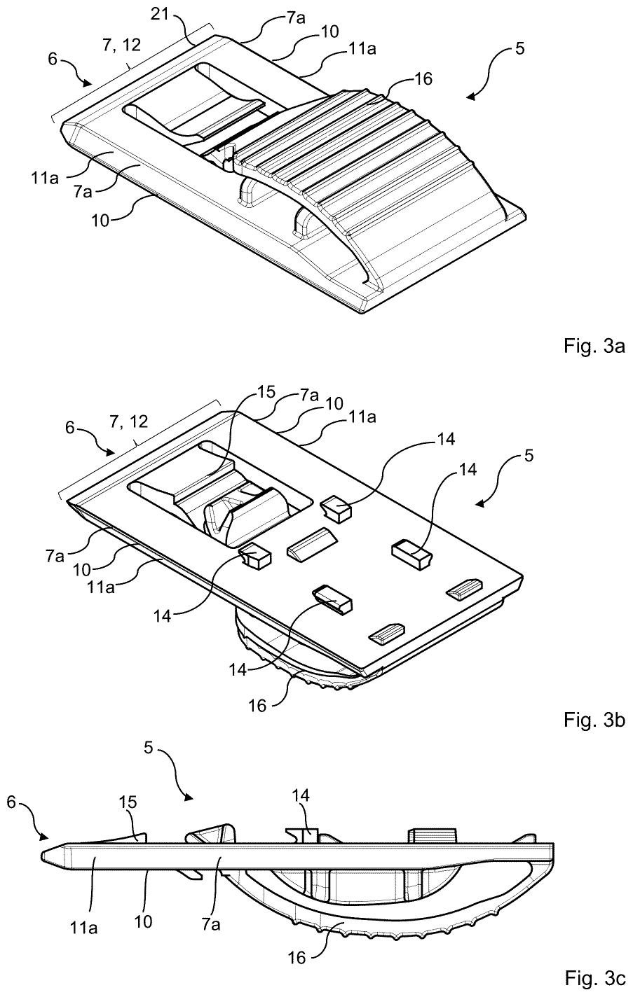

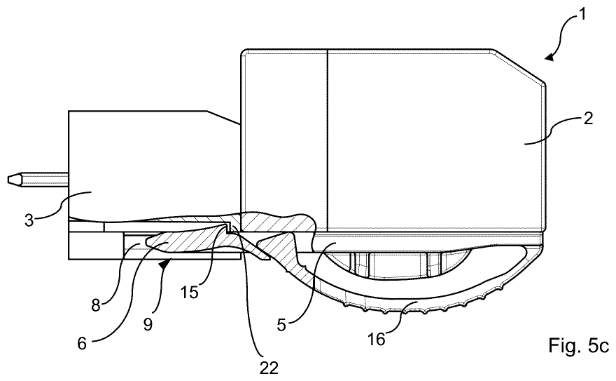

FIGS. 1a and 1b show a connector 2 according to an example for a connector assembly 1 shown in FIGS. 5a to 5c. The connector 2 has plug-in contact elements 4a, which, can be designed as several contact pin sockets arranged in a row to form a socket strip. The plug-in contact elements 4a are configured for establishing an electrical plug connection with plug-in contact elements 4b of a mating connector 3 shown in FIGS. 2a-2d. The surface of the connector 2 with the plug-in contact elements 4a forms a mating face 19, which is additionally provided with coding elements 20 to prevent mismating. The connector 2 has a mounting structure in the form of latching openings 18 for the detachable fastening of a locking element 5 shown in FIGS. 3a to 3c.

FIGS. 2a to 2d show a mating connector 3 according to an example in different views, FIG. 2c showing a sectional representation according to the section line B-B shown in FIG. 2b. The mating connector 3 has plug-in contact elements 4b, which are designed as several contact pins arranged in a row forming a pin header. The plug-in contact elements 4b are configured for establishing an electrical plug-in connection with plug-in contact elements 4a of the connector 2 shown in FIGS. 1a and 1b. In other words, the plug-in contact elements 4a of the connector 2 are assigned to the plug-in contact elements 4b of the mating connector 3. As shown in FIG. 2b, the surface of the mating connector 3 with the plug-in contact elements 4b forms a mating face 19, which is supplemented by coding elements 20 matching the coding elements 20 of the connector 2 to avoid mismating. The mating connector 3 has a guide seat 8 with a form-fit contour 9, which is set up for the form-fitting mounting and guiding of a guide section 6 of the locking element 5 shown in FIGS. 3a to 3c. The guide seat 8 is formed on a mating connector housing of the mating connector 3. The guide section 6 of the locking element 5 can be immersed in the guide seat 8 and can be held and guided therein in a form-fitting manner. The form-fitting mounting and guidance of the guide section 6 of the locking element 5 enables increased locking security with increased locking forces, which reliably secures the locking system against unintentional loosening in the event of tensile forces. By supporting the locking element 5 on the guide seat 8 of the mating connector 3, the locking element 5 is stabilized. The additional securing makes it possible to make the locking element 5 more elastic, which can make it easier to handle the locking element 5. The guide seat 8 forms a linear guide for the guide section 6 of the locking element 5, in which it is translationally movable. The form-fit contour 9 of the mating connector 3 has two bevel faces 11b on opposing inner contours of the guide seat 8, which run at an angle corresponding to the bevel surfaces 11a of the guide section 6 of the locking element 5, which will be explained below. The inclined bevel surfaces 11b of the form-fit contour 9 can be used to form a conical cross-sectional extension in the guide seat 8, which enables an undercut with the bevels 11a of the form-fit profile 7 of the locking element 5 and thus form-fitting guidance. As can be seen, for example, from FIG. 2b, the form-fit contour 9 of the guide seat 8 is designed as a symmetrical form-fit contour 9.

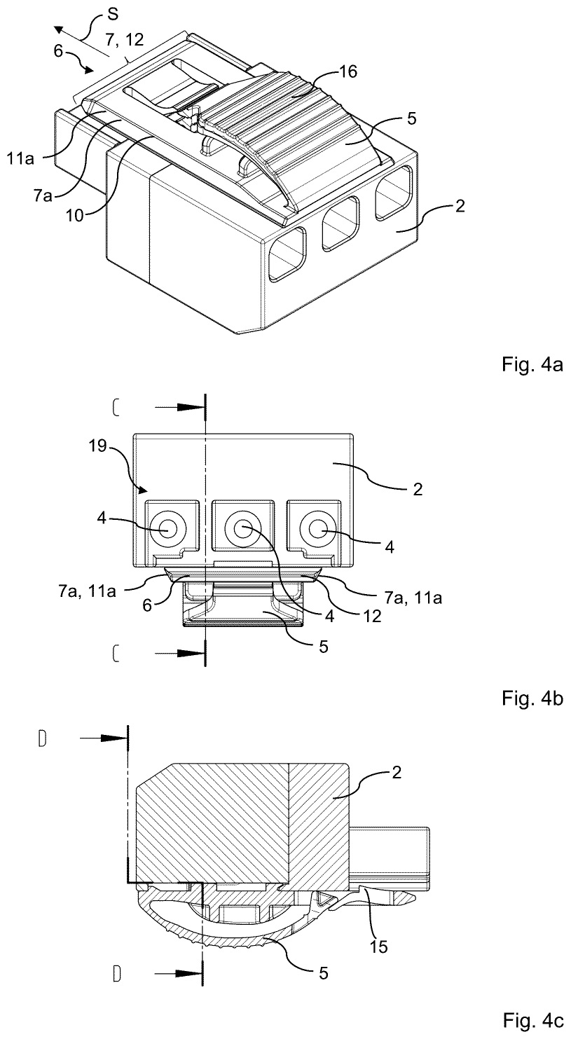

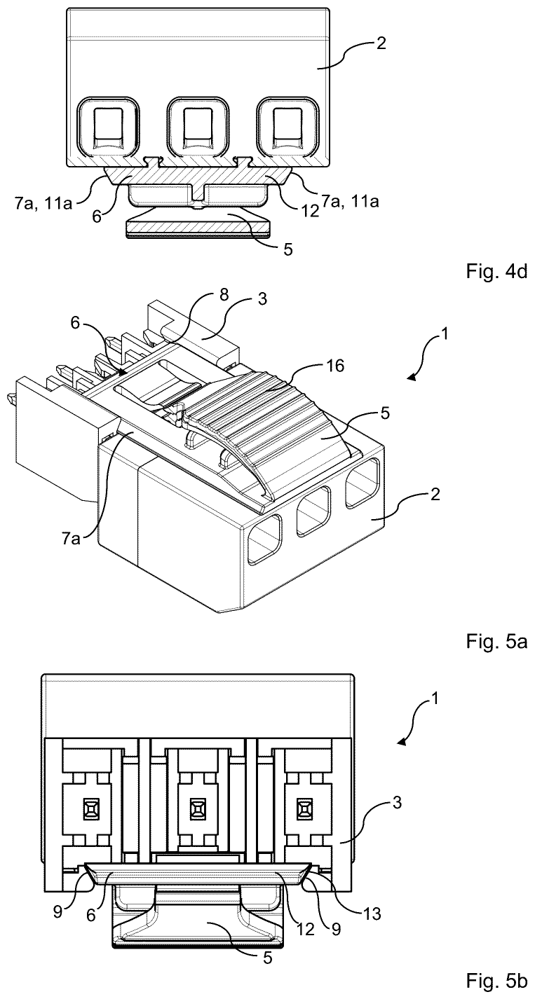

As can also be seen, for example, from FIG. 2b, the form-fit contour 9 of the guide seat 8 is formed as a dovetail contour 13 according to the example shown. A correspondingly designed dovetail profile 12 of the locking element 5 that matches the dovetail contour 13, as shown for example in FIG. 4b, can thus be guided in a form-fitting manner in the dovetail contour 13 and secured against falling out of the guide seat 8. The dimensions of the dovetail contour 13 and the dovetail profile 12 may be designed in such a way that they are provided with a clearance fit in order to facilitate the insertion and displacement of the guide section 6 in the guide seat 8. The dovetail contour 13 is essentially a negative form of the dovetail profile 12, wherein the dovetail profile 12 can be regarded as the protruding contour part of the locking element 5 and the dovetail contour 13 of the mating connector 3 as the recessed contour part.

FIGS. 3a to 3c show a locking element 5 according to an example in different views. The locking element 5 is arranged for assembly on the connector 2, as shown in more detail in FIGS. 4a to 4d and is designed as a separate locking latch to the connector 2. In the case of a connector assembly 1 as shown in FIGS. 5a to 5c, the locking element 5 is used to mechanically lock the connector 2 on the mating connector 3 in order to achieve a mechanical securing of the connector. In this case, the locking element 5 is set up for a detachable attachment to the mating connector 3. The locking element 5 is provided as a separate accessory element that can be attached to the connector 2 in a detachable manner. The locking element 5 has a guide section 6 with a lateral form-fit profile 7, which is set up for form-fitting mounting and guiding in the guide seat 8 of the mating connector 3. The guide section 6 is predominantly flat, is provided on an outer contour of the locking element 5 and, in relation to a connector assembly 1, is arranged on an end section of the locking element 5 facing the mating connector 3, as can be seen, for example, in FIG. 5a. The form-fit profile 7 of the locking element 5 is designed to undercut the form-fit contour 9 of the guide seat 8 of the mating connector 3, so that a reliable form-fit is achieved by the associated overlapping of the effective surfaces of the form-fit profile 7 and the form-fit contour 9.

As can be seen from FIGS. 3a and 3b, the form-fit profile 7 has two profile elements 7a formed on opposing side contours 10 of the locking element 5, which together form the form-fit profile 7. The side contours 10 of the locking element 5 extend essentially parallel to a mating direction S of the connector 2 shown in FIG. 4a with the locking element 5 arranged therein and orthogonally to an end edge 21 facing the mating connector 3. Due to the formation of the profile elements 7a on the side contours 10, the form-fit profile 7 can be described as a lateral form-fit profile 7. With such a lateral form-fit profile 7, it is possible to easily insert and displace the locking element 5 in the guide seat 8. In addition, the locking element 5 is stabilized laterally on the profile elements 7a and secured against unintentional detachment from the mating connector 3. The profile elements 7a extend over the entire side contours 10 of the locking element 5.

According to the example shown in FIGS. 3a to 3c, the form-fit profile 7 has two essentially identical but inclined bevel surfaces 11a in opposite directions as profile elements 7a. The bevel surfaces 11a are inclined corresponding to the bevel surfaces 11b shown in FIGS. 2a to 2d, so that the bevel surfaces 11a of the locking element 5 can engage behind the bevel surfaces 11b of the guide seat 6 of the mating connector 3 in a form-fitting manner and slide down on it in a guide direction along the guide seat 8. The inclined bevel surfaces 11a of the form-fit profile 7 can be used to form a conical cross-section extension of the guide section 6, which enables an undercut with the bevels 11b of the form-fit contour 9 of the mating connector 3 and thus form-fitting guidance. As can be seen, for example, from FIG. 4b, the form-fit profile 7 of the guide section 6 is designed as a symmetrical form-fit profile 7, so that a uniform application of force from the guide section 6 into the guide seat 8 of the mating connector 3 is possible. As can also be seen, for example, from FIG. 4b, the form-fit profile 7 of the guide section 6 is designed as a dovetail profile 12 and can therefore be guided as a positive fit in a corresponding dovetail contour 13 of the guide seat 8 of the mating connector 3 as already described.

For example, as can be seen in FIG. 3b, the locking element 5 has a first fastening structure 14 for fastening the locking element 5 to the connector 2. The first fastening structure 14 is designed as a locking structure, here in the form of latching lugs, and is used for the detachable, tool-free fastening of the locking element 5 to the connector 2, which has the latching openings 18 shown in FIG. 1a as a mounting structure for this purpose. The first fastening structure 14 is integrally designed with the locking element 5. Furthermore, the locking element 5 has a second fastening structure 15, designed integrally with the locking element 5, for fastening the locking element 5 to the mating connector 3. The second fastening structure 15 is designed as a locking structure, here designed as a latching tab, and is used for the detachable, tool-free fastening of the locking element 5 to the mating connector 3, which has a latching edge 22 shown in FIG. 5c as a mounting structure for this purpose. Due to the fastening structures 14, 15, which are designed as locking structures, the locking element 5 can be easily attached. The form-fitting mounting and guiding of the locking element 5 in the guide seat 8 allows for the locking element 5 to be designed more elastically, so that handling and a locking or unlocking process are simplified, but an unintentional detachment of the locking element 5 can be reliably prevented.

To carry out an unlocking, the locking element 5 has an unlocking element 16, which is designed as an elastically deformable tab and can lever the second fastening structure 15, which is designed as a latching tab, from its engagement with the latching edge 22 when the unlocking element 16 is operated. The unlocking element 16 is arranged between the side contours 10 of the locking element 5 and partially spans it in the form of a bridge.

FIGS. 4a to 4d show a connector 2 in accordance with FIGS. 1a and 1b with a locking element 5 in accordance with FIGS. 3a to 3c arranged therein in different views, wherein FIG. 4c shows a sectional representation in accordance with the section line C-C shown in FIG. 4b and FIG. 4d shows a sectional representation in accordance with the section line D-D shown in FIG. 4c. As can be seen, for example, from FIGS. 4a and 4c as well as from FIG. 5a, the locking element 5 extends mainly along the connector 2. In other words, a comparatively smaller proportion of the locking element 5 extends along the mating connector 3. The connector 2 can be routed to a mating connector 3 with the locking element 5 arranged herein in a mating direction S in order to establish an electrical connection with the mating connector 3. When approaching the mating connector 3, the locking element 5 with its form-fit profile 7 can increasingly dip into its guide seat 8. The guide section 6 extends adjacent to the mating face 19 of the connector 2. As can be seen in FIG. 4c, the second fastening structure 15 is prepared for establishing a snap-in connection with the mating connector 3 and automatically establishes a mechanical snap-in connection to the mating connector 3 by engaging behind the latching edge 22.

FIGS. 5a to 5c show a connector assembly 1 with the components described above in an assembled state. In this case, guide section 6 of the locking element 5 is received in the guide seat 8 of the mating connector 3 in a positive fit. The connector 2 and the mating connector 3 are effectively connected to each other and locked to each other by the locking element 5. By operating the unlocking element 16, the locking element 5 can release the second fastening structure 15 from the snap-in connection with the latching edge 22 and release the lock.

As can be seen in FIG. 5c, the mating connector 3 has a positive contour 9 with a guide seat 8 which is designed to receive the guide section 6 of the locking element 5 and connect it in a form-fit.

With the described connector assembly 1 and the associated components described in the form of the connector 2, mating connector 3 and locking element 5 of the connector assembly 1, an easy-to-handle and reliably effective mechanical securing of a connector assembly 1 can be made possible. In particular, the risk of unintentional release of the lock in the event of tensile forces acting on the locking element 5 is reduced.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electrical connector assembly comprising:
a connector; and
a mating connector, the connector and mating connector each having electrical plug-in contact elements assigned to each other; and
a locking element arranged on the connector to mechanically lock the connector to the mating connector, the locking element being arranged for a detachable attachment to the mating connector;
a guide section arranged on the locking element, the guide section having a form-fit profile; and
a guide seat arranged on the mating connector, the guide seat has a form-fit contour for the form-fitting mounting and guiding of the locking element to the mating connector.

2. The connector assembly according to claim 1, wherein the form-fit profile of the locking element is designed to undercut the form-fit contour of the mating connector.

3. The connector assembly according to claim 1, wherein a profile element of the form-fit profile is formed on a side contour of the locking element.

4. The connector assembly according to claim 3, wherein in each case one profile element of the form-fit profile is formed on two opposing side contours of the locking element.

5. The connector assembly according to claim 1, wherein the form-fit profile of the locking element and the form-fit contour of the mating connector are formed as correspondingly inclined bevel surfaces.

6. The connector assembly according to claim 1, wherein the form-fit profile is formed as a symmetrical form-fit profile, and wherein the form-fit contour is formed as a symmetrical form-fit contour.

7. The connector assembly according to claim 1, wherein the form-fit profile is formed as an asymmetrical form-fit profile and wherein the form-fit contour is formed as an asymmetrical form-fit contour.

8. The connector assembly according to claim 1, wherein the form-fit profile is formed as a dovetail profile and the form-fit contour as a dovetail contour.

9. The connector assembly according to claim 1, wherein the locking element has a first fastening structure for fixing the locking element to the connector.

10. The connector assembly according to claim 1, wherein the locking element has a second fastening structure for fastening the locking element to the mating connector.

11. The connector assembly according to claim 10, wherein the first fastening structure and/or the second fastening structure are designed as a snap-in structure.

12. The connector assembly according to claim 1, wherein the locking element has an unlocking element.

13. The connector assembly according to claim 1, wherein the locking element is designed as a locking latch.

14. The connector assembly according to claim 1, wherein the connector assembly has a connecting component that extends adjacent to the guide seat of the mating connector.

15. An electrical mating connector for the connector assembly according to claim 1, wherein the mating connector has a guide seat with a form-fit contour for the form-fitting mounting and guiding of a locking element.

16. A locking element for the connector assembly according to claim 1, wherein the locking element has a guide section with a form-fit profile.

17. A set comprising:
a connector;
a mating connector; and
a locking element for forming the electrical connector assembly according to claim 1.
